(19) United States
(12) Patent Application Publication
(10) Pub. No.: US 2021/0012014 A1
(43) Pub. Date: Jan. 14, 2021

(54) VULNERABILITY CHECKING SYSTEM, DISTRIBUTION SERVER, VULNERABILITY CHECKING METHOD AND PROGRAM

(71) Applicant: NEC Corporation, Minato-ku, Tokyo (JP)

(72) Inventor: Kazuya YAMAMOTO, Tokyo (JP)

(73) Assignee: NEC Corporation, Minato-ku, Tokyo (JP)

(21) Appl. No.: 16/980,163

(22) PCT Filed: Mar. 19, 2019
(86) PCT No.: PCT/JP2019/011584

§ 371 Date: Sep. 11, 2020

(30) Foreign Application Priority Data
Mar. 20, 2018 (JP) 2018-052787

(51) Int. Cl. G06F 21/57

(52) U.S. Cl. CPC G06F 21/577; G06F 2221/033

(57) ABSTRACT

A vulnerability checking system includes a terminal, a management server and a distribution server. The management server manages software installed in the terminal. The distribution server distributes information related to software in which a vulnerability is estimated to be present, as new vulnerability information to the management server. The distribution server includes a collection part and an analysis part. The collection part collects descriptions related to software vulnerabilities from information published on a network. The analysis part analyzes the collected descriptions, calculates, as a degree of activity, the number of descriptions related to vulnerabilities of software that is a target of vulnerability checking within a prescribed period, and generates new vulnerability information according to the calculated degree of activity.

### CROSS-REFERENCE TO RELATED APPLICATIONS

The present application claims priority from Japanese Patent Application No. 2018-052787 (filed on Mar. 20, 2018), the content of which is hereby incorporated in its entirety by reference into this specification.

The present invention relates to a vulnerability checking system, a distribution server, a vulnerability checking method and a program.

### BACKGROUND

Many items of software are installed in IT (Information Technology) resources used in organizations such as enterprises and the like, including personal computers and servers.

Attackers aiming at confidential information in an organization often use an approach of searching for vulnerabilities in software installed in various IT resources, and attacking the vulnerabilities. In order to protect IT resources from such attacks, it is necessary to promptly obtain information on vulnerabilities present in software and to quickly identify terminals having a vulnerability before an attack arrives. If a terminal having a vulnerability is identified, it is possible to deal with eliminating the vulnerability.

Here, there is software centrally manages resource information (for example, terminal name, installed software names, software versions and the like) of a terminal in an organization and manages vulnerability. Below, this software is denoted “vulnerability management software”.

When a vulnerability is published on a vendor website, the vulnerability management software refers to the vulnerability information, and the software provider creates a checking script for identifying a terminal having the vulnerability. In addition, this vulnerability management software distributes the created checking script to terminals and executes checking (causes the checking to be executed) at each terminal. Thereafter, if it is known that a vulnerability is present, the administrator of a terminal in the organization completes dealing with the issue by performing an appropriate policy such as applying a patch or updating the software.

By using the vulnerability management software in this way, it is possible to prevent an attack by an attacker. However, the provider of the vulnerability management software waits for publication of information by a trustworthy public organization and must create a checking script in accordance with the vulnerability in a case where a checking script is not included even after publication of the information.

This type of work takes at least one day at earliest and may take several days in some cases. During this time, an enterprise that has installed the vulnerability management software has no defensive means to defend against an attack by an attacker, and if a countermeasure has not been otherwise implemented, an attack that strikes at the vulnerability in question may be successful.

As a means of solving this type of problem, a method may be considered whereby, before information is published by the press or the like, the information is obtained in advance from a public organization under a confidentiality agreement. However, there is a wide variety of types of software contained in a terminal, and it is not realistic to make individual contracts and obtain information in advance for all items of software.

Vulnerability information is generated unpredictably, and even if there is a contract, the extent to which information (detailed information) can be obtained in advance is indefinite.

In addition, as an indirect defense means against attack, if communication is detected that attacks the vulnerability in question at a gateway apparatus such as an IDS (Intrusion Detection System) or an IPS (Intrusion Protection System) or the like in a communication path, a countermeasure may be considered such as blocking or log acquisition. However, for information as to what type of communication is to be blocked, a signature corresponding to each attack must be registered, and the essential problem is not solved with regard to the point that there is an interval from disclosing vulnerability information to an initial response to handle the problem.

In checking a vulnerability, checking is regularly performed as to whether a software version matches a certain condition, or whether a certain function is valid, and it is also considered to take measures to periodically collect all parameters for which checking may be performed. However, since the number of checking targets being represented in the form of multiplying the number of software items by the checking items, it is not realistic to periodically and continuously collect all information from both the viewpoint of processing capability and the viewpoint of disk capacity.

Patent Literature 1 discloses technology for extracting vulnerability information collected from Web pages and providing useful information to a security administrator.

### CITATION LIST

### Patent Literature

[PTL 1]
International Publication No. WO2017/221858

### SUMMARY

### Technical Problem

It is to be noted that the disclosure of the abovementioned cited literature is incorporated herein by reference thereto. The following analysis is given according to the present inventor.

As described above, Patent Literature 1 discloses technology for extracting information related to vulnerabilities, and providing the information to a administrator. However, the focus of Patent Literature 1 is technology for retrieving and providing useful information for prompt reaction after the occurrence of a cyber-attack. Therefore, the technology disclosed in Patent Literature 1 cannot be applied to predicting dangers in advance and initiating checking with regard to the occurrence of common vulnerabilities.

It is a principal object of the present invention to provide a vulnerability checking system, a distribution server, a vulnerability checking method and a program, that contribute to enabling rapid acquisition of vulnerability information and early-stage initiation of vulnerability checking.

### Solution To Problem

According to a first aspect the present invention and disclosure, there is provided a vulnerability checking system comprising: a terminal; a management server that manages software installed in the terminal; and a distribution server that distributes information related to software in which a vulnerability is estimated to be present, as new vulnerability information, to the management server; wherein the distribution server comprises: a collection part that collects descriptions related to vulnerability of software, from information published on a network; and an analysis part that analyzes the collected descriptions, calculates, as a degree of activity, the number of descriptions related to vulnerability of software that is a target for vulnerability checking within a prescribed period, and generates the new vulnerability information according to the calculated degree of activity.

According to a second aspect the present invention and disclosure, there is provided a distribution server including: a collection part that collects descriptions related to software vulnerability from information published on a network; and an analysis part that analyzes the collected descriptions, calculates, as a degree of activity, the number of descriptions related to vulnerability of software that is a target for vulnerability checking within a prescribed period, and generates new vulnerability information that is information related to software in which a vulnerability is estimated to be present, according to the calculated degree of activity; wherein the new vulnerability information is distributed to a management server that manages software installed in a terminal.

According to a third aspect the present invention and disclosure, there is provided a vulnerability checking method, in a distribution server that distributes information related to software in which a vulnerability is estimated to be present, as new vulnerability information, to a management server that manages software installed in a terminal, the method, including: collecting descriptions related to software vulnerability from information published on a network; analyzing the collected descriptions and calculating, as a degree of activity, the number of descriptions related to vulnerability of software that is a target for vulnerability checking within a prescribed period; and generating new vulnerability information that is information related to software in which a vulnerability is estimated to be present, according to the calculated degree of activity.

According to a fourth aspect the present invention and disclosure, there is provided a program that causes a computer which is installed in a distribution server that distributes information related to software in which a vulnerability is estimated to be present, as new vulnerability information, to a management server that manages software installed in a terminal, to execute processing, including: collecting descriptions related to software vulnerability from information published on a network; analyzing the collected descriptions and calculating, as a degree of activity, the number of descriptions related to vulnerability of software that is a target for vulnerability checking within a prescribed period; and generating new vulnerability information that is information related to software in which a vulnerability is estimated to be present, according to the calculated degree of activity.

It is to be noted that this program may be recorded on a computer-readable storage medium. The storage medium may be non-transient such as semiconductor memory, a hard disk, a magnetic recording medium, an optical recording medium or the like. The present invention may be embodied as a computer program product.

### Advantageous Effects Of Invention

According to the respective aspects of the present invention and disclosure, there is provided a vulnerability checking system, a distribution server, a vulnerability checking method and a program that contribute to enabling rapid acquisition of vulnerability information and early-stage initiation of vulnerability checking.

### BRIEF DESCRIPTION OF DRAWINGS

FIG. 1 is a diagram for illustrating an outline of an exemplary embodiment.

FIG. 2 is a diagram showing an example of a schematic configuration of a vulnerability checking system according to a first exemplary embodiment.

FIG. 3 is a block diagram showing an example of a hardware configuration of a distribution server according to the first exemplary embodiment.

FIG. 4 is a diagram for illustrating vulnerability information included in Web-published information.

FIG. 5 is a flowchart showing an example of operations of collecting published information by a distribution server.

FIG. 6 is a diagram showing an example of registered content of a public information database.

FIG. 7 is a flowchart showing an example of operations of inputting vulnerability checking information of a distribution server.

FIG. 8 is a flowchart showing an example of operations of generating new vulnerability information by a distribution server.

FIG. 9 is a sequence diagram showing an example of operations of a management server and a terminal.

FIG. 10 is a flowchart showing an example of operations of confirming a vulnerability by a administrator.

### DESCRIPTION OF EXEMPLARY EMBODIMENTS

First, a description is given concerning an outline of an exemplary embodiment. It is to be noted that reference symbols in the drawings attached to this outline are added to respective elements for convenience as examples in order to aid understanding, and there is no intention to limit the invention in any way. Connection lines between blocks in respective diagrams may be bidirectional or unidirectional. Unidirectional arrows schematically show flow of main signals (data), but do not exclude bidirectionality. In addition, although not explicitly disclosed in circuit diagrams, block diagrams, internal configuration diagrams, and connection diagrams, etc. shown in the disclosure of the present application, input ports and output ports are present at respective input terminals and output terminals of each connection line. The same applies for input output interfaces.

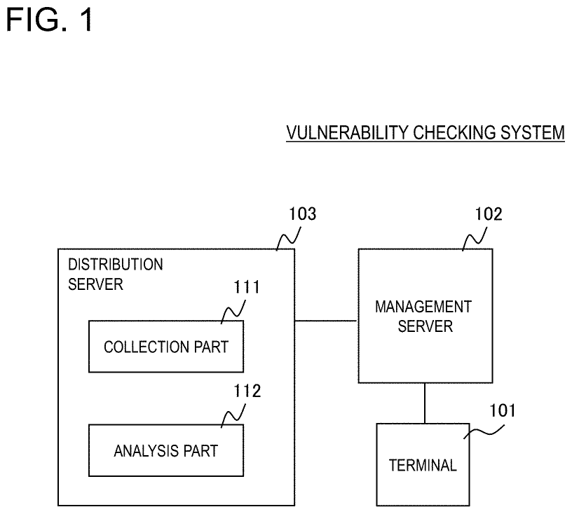

The vulnerability checking system according to an exemplary embodiment includes a terminal 101, a management server 102, and a distribution server 103 (refer to FIG. 1). The management server 102 manages software installed in the terminal 101. The distribution server 103 distributes, to the management server 102 as new vulnerability information, information related to software in which a vulnerably is estimated to be present. The distribution server 103 includes a collection part 111 and an analysis part 112. The collection part 111 collects descriptions related to software vulnerabilities from information published on a network. The analysis part 112 analyzes the collected descriptions, calculates, as a degree of activity, the number of descriptions related to vulnerabilities of software that is a target for vulnerability checking within a prescribed period, and generates new vulnerability information according to the calculated degree of activity.

In a case where a vulnerability of software included in an information terminal such as a personal computer or server or the like is discovered by someone, the information in question is shared via media. In the disclosure of the present application, it is assumed that the abovementioned information is shared on a network (medium) such as the Internet. In the vulnerability checking system according to an exemplary embodiment, information (published information) exchanged on the Web, such as a website or the like on the Internet, is analyzed. More concretely, the distribution server 103 estimates whether the probability is high regarding what exchange of vulnerability information is performed with which what software is concerned. Furthermore, the distribution server 103 can automatically start checking a terminal that has a possible vulnerability, based on the estimated information. That is, the abovementioned vulnerability checking system proposes a mechanism for performing automatic collection and automatic analysis of published information on a network, and in accordance with the degree of activity of information exchange concerning vulnerability information, starting checking of several checking items set in advance, before publishing of the vulnerability information.

The abovementioned vulnerability checking system actively uses that vulnerability information is exchanged in a community such as the dark web or the like, before the vulnerability information is officially published by a vendor. Concretely, vulnerability information is already recognized and some sort of information exchange occurs in the abovementioned type of community before publication of vulnerability information by the vendor. The abovementioned vulnerability checking system uses a property which characteristic of such vulnerability information has (occurrence of information exchange before publication by a vendor) to start checking of vulnerability information in advance. That is, vulnerability information exchanged in advance can be rapidly obtained. By obtaining the vulnerability information in advance, it is possible to start checking at an early stage as to whether or not software corresponding to the vulnerability information in question is installed in the terminal 101.

A more detailed description is given concerning concrete exemplary embodiments below, making reference to the drawings. It is to be noted that in each of the exemplary embodiments, the same symbols are attached to the same configuration elements and descriptions thereof are omitted.

### First Exemplary Embodiment

A more detailed description is given concerning a first exemplary embodiment, using the drawings.

### [Description of Configuration]

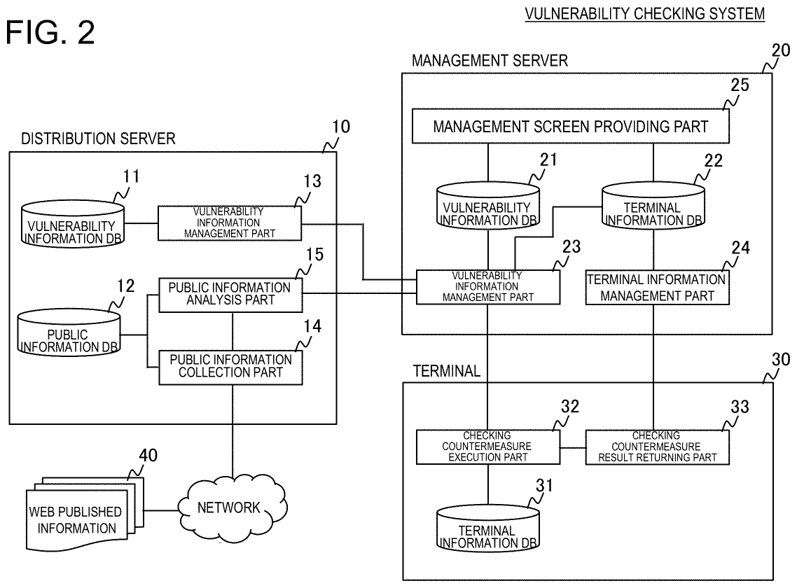

FIG. 2 is a diagram showing an example of a schematic configuration of a vulnerability checking system according to the first exemplary embodiment. Referring to FIG. 2, the vulnerability checking system includes a distribution server 10, a management server 20 and a terminal 30.

The distribution server 10 is an apparatus that manages vulnerability information and published information, and distributes to the management server 20. More concretely, the distribution server 10 is an apparatus that distributes information related to software in which a vulnerably is estimated to be present, as “new vulnerability information”, to the management server 20.

The distribution server 10 is configured to include a vulnerability information database (DB) 11, a public information database 12, a vulnerability information management part 13, a public information collection part 14, and a public information analysis part 15.

The vulnerability information database 11 is a database storing: a name of software that has a vulnerability, a condition under which a vulnerability becomes apparent (for example, version or validity/invalidity of a particular function, a parameter), CVE (Common

Vulnerabilities and Exposures) number, publication date or the like.

The vulnerability information management part 13 is a part to manage the vulnerability information database 11. On obtaining vulnerability information from a system administrator or the like, the vulnerability information management part 13 stores the information in question in the vulnerability information database 11.

The public information collection part 14 is a part to collect descriptions related to software vulnerabilities from information published on a network. The descriptions collected by the public information collection part 14 are stored in the public information database 12. That is, the public information database 12 is a database that stores information processed from Web public information 40 by the public information collection part 14.

It is to be noted that the public information collection part 14 can regards one sentence of a text written to a site as a unit of the information collection. For example, one remark by a particular user is taken as an information collection unit by the public information collection part 14. Or, in a case of collecting information from a site such as bulletin board or the like, one thread may be taken as an information collection unit. That is, the public information collection part 14 may collect public information in arbitrary units.

The public information analysis part 15 is a part to analyze descriptions collected by the public information collection part 14. More concretely, the public information analysis part 15 calculates, as a degree of activity, the number of descriptions related to vulnerabilities of software that is a target for vulnerability checking within a prescribed period among the collected descriptions, and generates new vulnerability information according to the calculated degree of activity.

The public information analysis part 15 analyzes information stored in the public information database 12, and, based on a result thereof, estimates software having a vulnerability. In a case of a high probability of a new vulnerability being present in the software, the public information analysis part 15 transmits, to the management server 20, detailed information of the software (for example, software name, version) estimated to have the new vulnerability, as new vulnerability information.

As described above, the public information analysis part 15 performs the abovementioned estimation based on the “degree of activity” related to a vulnerability of software that is a target for vulnerability checking. It is to be noted that the degree of activity may be taken as the frequency or the number of times a user mentions as to a software vulnerability within a prescribed time. Concretely, if vulnerability information related to particular software occurs frequently in one day, the degree of activity related to the vulnerability in question is “high”. In contrast, if almost no vulnerability information related to particular software occurs in one day, the degree of activity related to the vulnerability in question is “low”.

The management server 20 is an apparatus which is installed for an organization such as an enterprise where a terminal 30 to be managed is used and manages software installed in the terminal 30. More concretely, the management server 20 is an apparatus that manages vulnerability information of the terminal 30. The management server 20 instructs the terminal 30 to check the state of software, in the terminal 30, as identified by new vulnerability information. That is, the management server 20 checks whether or not software determined to have a new vulnerability by the distribution server 10 is installed in the terminal 30.

The management server 20 is configured to include a vulnerability information database 21, a terminal information database 22, a vulnerability information management part 23, a terminal information management part 24, and a management screen providing part 25.

Items (content, information) included in the vulnerability information database 21 are the same as those of the vulnerability information database 11. The vulnerability information database 21 stores information distributed by the distribution server 10.

The vulnerability information management part 23 is provided with a function for receiving information distributed by the distribution server 10, a function for storing the information in question in the vulnerability information database 21, and a function for distributing a script to the terminal 30, which is a target for a vulnerability check and countermeasure.

On obtaining new vulnerability information from the distribution server 10, the vulnerability information management part 23 transmits the information in question to the terminal 30. The vulnerability information management part 23 queries whether or not software corresponding to the new vulnerability information is present in the terminal 30, by transmitting the new vulnerability information to the terminal 30.

The terminal information database 22 is a database that holds software installed in each terminal 30 that is to be managed, and versions thereof. The terminal information management part 24 is a part to manage information collected from the terminal 30. Concretely, the terminal information management part 24 registers software configuration and the like of each terminal 30 in the terminal information database 22.

The management screen providing part 25 is a part to generate a management screen based on information of the 2 databases, and to generate a screen for providing information to a administrator of an organization (for example, a security administrator). The administrator can confirm vulnerability information or terminal information of the organization using the screen provided by the management screen providing part 25.

It is to be noted that only one terminal 30 is illustrated in FIG. 2, but in actuality the management server 20 manages a plurality of terminals 30.

The terminal 30 is, for example, an IT resource such as a personal computer, a server or the like. The terminal 30 is a target of management by the management server 20. That is, the management server 20 and the terminal 30 have a relationship in which the former manages vulnerability information and terminal information, and the latter is managed.

The terminal 30 is configured to include a terminal information database 31, a checking countermeasure execution part 32, and a checking countermeasure result returning part 33.

The checking countermeasure execution part 32 has a function to execute a prescribed script in the apparatus itself, using a script received from the management server 20.

The checking countermeasure result returning part 33 transmits an execution result of the script in question to the management server 20.

The terminal information database 31 is a database that holds software installed in the apparatus itself, and versions thereof.

The checking countermeasure execution part 32 accesses the terminal information database 31, and confirms whether or not software corresponding to the new vulnerability information is present in the apparatus itself. The confirmation result is transmitted to the management server 20 via the checking countermeasure result returning part 33.

### [Hardware Configuration]

Subsequently, a description is given of a hardware configuration of each apparatus, making reference to the drawings.

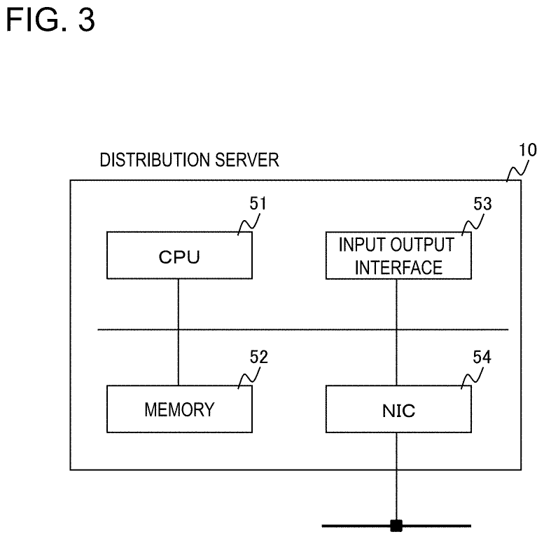

FIG. 3 is a block diagram showing an example of a hardware configuration of the distribution server 10 according to the first exemplary embodiment.

The distribution server 10 may be configured by an information processing apparatus (computer) and is provided with a configuration exemplified in FIG. 3. For example, the distribution server 10 is provided with a CPU (Central Processing Unit) 51, a memory 52, an input output interface 53, and an NIC (Network Interface Card) 54 which is a communication means, connected to each other by an internal bus.

The configuration shown in FIG. 3 is not intended to be limited to the hardware configuration of the distribution server 10. The distribution server 10 may include hardware not shown in the drawings, and need not be provided with the input output interface 53 depending on the necessity. The number of CPUs included in the distribution server 10 is not intended to be limited to the example shown in FIG. 3, and for example, a plurality of CPUs 51 may be included in the distribution server 10.

The memory 52 may be RAM (Random Access Memory), ROM (Read Only Memory), or an auxiliary storage apparatus (hard disk etc.).

The input-output interface 53 is a part that forms an interface for a display apparatus or input apparatus not shown in the drawings. The display apparatus is, for example, a liquid crystal display or the like.

The input apparatus is, for example, an apparatus that receives a user operation such as that of a keyboard, a mouse, or the like.

Functionality of the distribution server 10 is realized by the abovementioned processing modules. The processing modules are realized, for example, by the CPU 51 executing a program stored in the memory 52. The program may be downloaded via a network, or may be updated using a storage medium that stores the program. Furthermore, the abovementioned processing module may be realized by a semiconductor chip. That is, it is sufficient to have a part that executes functions performed by the abovementioned processing modules by some type of hardware and/or software.

It is to be noted that the management server 20 and the terminal 30 may also be configured by an information processing apparatus similar to the distribution server 10, and since the basic hardware configuration has no differences from the distribution server 10, a description is omitted.

Before describing operations of a vulnerability checking system according to the first exemplary embodiment, a description is given concerning natures of Web public information 40.

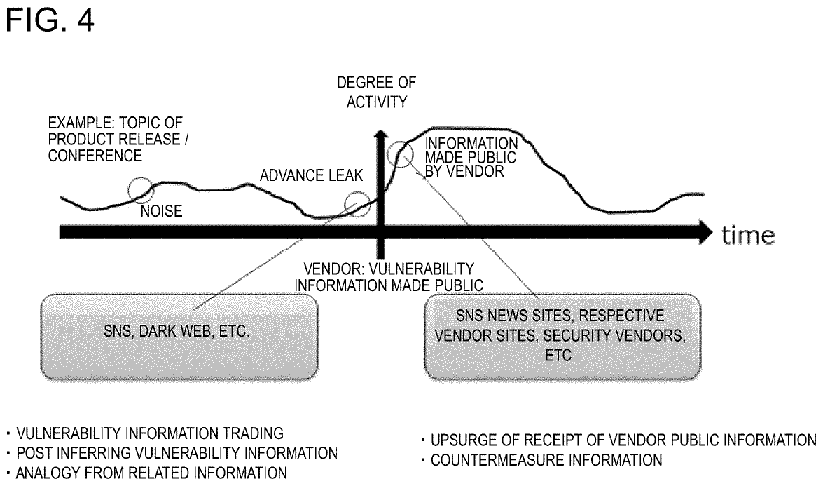

Vulnerability information included in the Web public information 40 is assumed to have the following nature. Concretely, timeline flow as shown in FIG. 4 is assumed until vulnerability information of particular software is discovered by a vendor, then the vulnerability information in question is published and countermeasures are taken.

FIG. 4 is a graph where the horizontal axis shows time, and the vertical axis shows degree of activity. As shown in FIG. 4, the degree of activity reaches a peak after the vendor has published vulnerability information. Thereafter, the degree of activity gradually abates accompanying execution of countermeasures against vulnerability (degree of activity decreases).

However, some sort of information exchange may occur in a community where vulnerability information is already recognized, before publication of the vulnerability information by the vendor. Concretely, as shown in FIG. 4, there is a time (period) in which the degree of activity becomes high outside peak time also (before peak time).

In the vulnerability checking system according to the first exemplary embodiment, a nature of the degree of activity of such vulnerability information is used to start checking of vulnerability information in advance. Concretely, in the first exemplary embodiment, before the vendor officially announces a vulnerability, checking is started as to whether or not software has installed in the terminal 30, for which software a vulnerability has become a topic in the abovementioned community.

Next a description is given concerning handling of public information.

In the disclosure of the present application, with regard to public information, information is classified into 2 types: information used specifically for each software item, and information used commonly for a way-of-thinking about vulnerabilities.

Concretely, public information is classified into information for uniquely identifying a software item, and information related to vulnerability. In the description below, information for uniquely identifying a software item is denoted software (SW) information.

SW information is information such as software name, version information, setting values or the like. SW information is managed with 1 item of software as 1 unit.

Information regarding vulnerability is further classified into 2 types of information.

The first information is a term related to vulnerability.

The second information is a term used when exchange of information related to a known vulnerability, not to a new vulnerability, is performed.

In the description below, the first information is denoted “vulnerability term”, and the second information is denoted “non-new vulnerability term”.

Examples of vulnerability terms include “vulnerability”, “security hole”, “root”, “auth” and the like. Examples of non-new vulnerability term include “seminar”, “study group”, “former” and the like.

It is to be noted that information as to which type of term or information is corresponding to the abovementioned SW information, vulnerability terms, and non-new vulnerability terms, is registered in advance in a database or table that can be accessed by respective processing modules of the distribution server 10.

### [Description of Operations]

Subsequently, a description is given concerning operations of respective apparatuses, making reference to the drawings.

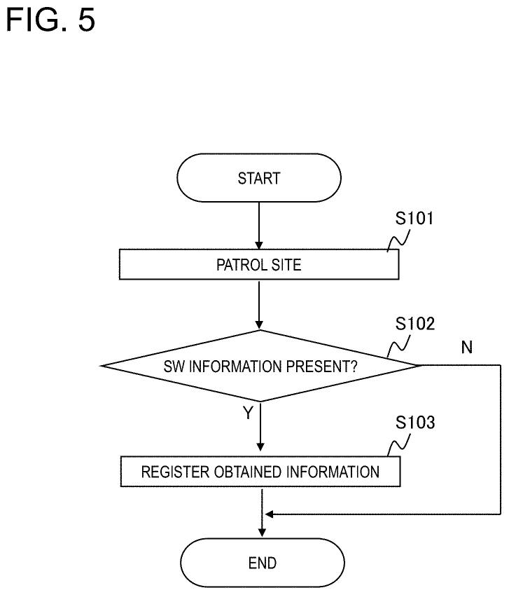

FIG. 5 is a flowchart showing an example of operations of collecting public information by the distribution server 10. First, a system administrator performs settings related to operations of collecting public information in the distribution server 10. Concretely, the administrator sets a “URL (Uniform Resource Locator) of a site to be patrolled”, a “patrol method”, a “patrol condition”, “importance of a site to be patrolled”, or the like, in the distribution server 10.

For example, the administrator sets URLs, patrolling of links in a URL (patrol method), extracting information of a particular tag (patrol condition) and the like, in the distribution server 10.

It is to be noted that the importance of a site to be patrolled is an item representing the reliability of a site to be patrolled as an information source. For example, in the case of a site updatable by many users, the importance is set to be low, and in the case of a public site of official information run by a vendor, the importance is set to be high (for example, maximum). The distribution server 10 may use this importance to make a response, such as by patrolling a site with high importance on a preferential basis.

The distribution server 10 patrols respective sites based on content (patrol condition) that has been set (step S101). On this occasion, the distribution server 10 patrols respective sites in a fixed period, and executes registered patrol methods in order. In this way, the distribution server 10 collects descriptions related to software vulnerabilities, based on setting information (information set by a administrator) related to a site to be accessed in order to collect descriptions related to software vulnerabilities.

On obtaining information from a patrolled site, the public information collection part 14 of the distribution server 10 determines whether or not vulnerability information is included in the obtained information (step S102). Concretely, the public information collection part 14 judges whether or not at least one of the abovementioned SW information, the vulnerability terms and the non-new vulnerability terms is included in the obtained information.

If the obtained information (descriptions) does not include the SW information, a vulnerability term, or a non-new vulnerability term (step S102, No branch), the distribution server 10 finishes processing.

If vulnerability information is included (step S102, Yes branch), the public information collection part 14 gives an attribute corresponding to a term or wording included in the obtained information, to the obtained information, and registers it in the public information database 12 (step S103).

For example, in a case of obtaining the information “vulnerability present in version 01 of software A”, the public information collection part 14 arranges the obtained information based on the SW information of the information in question, along with giving an attribute of “vulnerability term present” to the information in question, to be registered in the public information database 12. Or, in a case of obtaining the information “report of vulnerability present in version 01 of software A, in study group”, the public information collection part gives an attribute of “vulnerability term present”, “non-new vulnerability term present” to the information in question, to be registered in a public information database 12.

The public information collection part 14 registers an ID (Identifier) to identify the obtained information along with date and time of obtaining the information in the public information database 12.

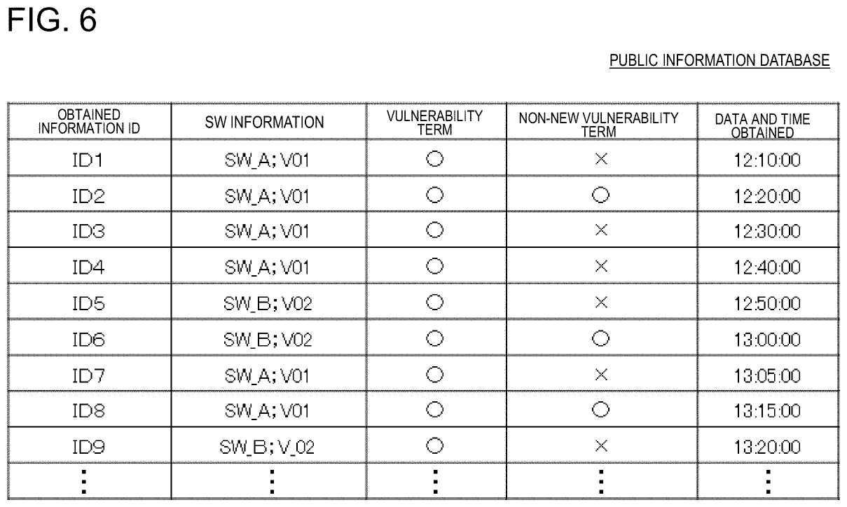

The public information database 12 as shown in FIG. 6 is built by operations of the public information collection part 14. Referring to FIG. 6, management is performed, for example, for each software information item (version 01 of software A, version 02 of software B), as to whether or not a vulnerability term or a non-new vulnerability term is included in the respective obtained information items.

In this way, the distribution server 10 makes a judgment as to whether the collected information is related to any of the abovementioned 3 classifications, and if there is a match, adds related information to the public information database 12. Information stored in the public information database 12 is not merely a word listing, but related information dependent on analysis technology used is specified.

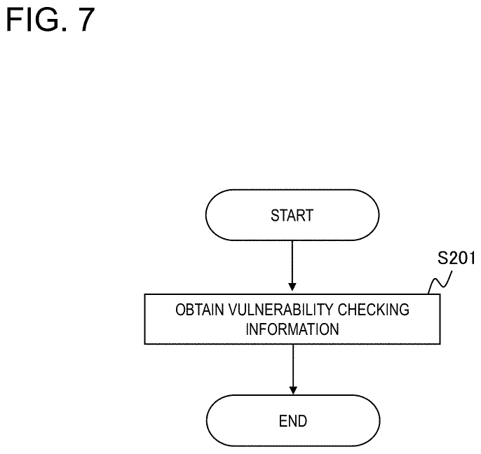

FIG. 7 is a flowchart showing an example of operations of inputting vulnerability checking information of the distribution server 10.

The administrator inputs information related to a target for checking of vulnerability at arbitrary timing, into the distribution server 10. For example, the administrator inputs information of a target for checking of vulnerability recognized before starting operation of a system. For example, the administrator specifies software name and version thereof and input them as a “target for checking of vulnerability” into the distribution server 10. Or, the administrator can input a target for checking of vulnerability, based on public information referred to after starting operation of the system.

The public information analysis part 15 of the distribution server obtains vulnerability checking information in order to identify software that is a target for vulnerability checking, from the administrator (step S201). Concretely, the public information analysis part 15 obtains a target for vulnerability checking of 1 record with a software name that is a target for vulnerability checking, a keyword (for example, version) representing setting item and so on.

In a case where a concrete checking script or command or the like can be prepared for vulnerability checking, the administrator inputs these information items into the distribution server 10.

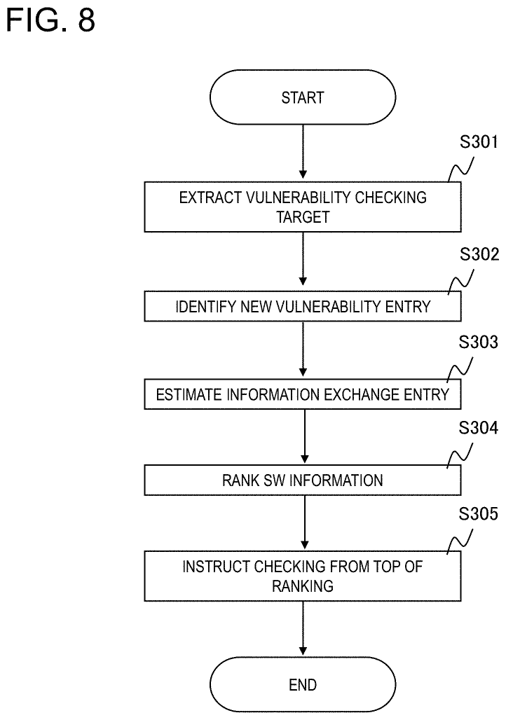

Subsequently, a description is given concerning generation of new vulnerability information by the distribution server 10. FIG. 8 is a flowchart showing an example of operations of generating new vulnerability information by the distribution server 10.

The distribution server 10 calculates degree of activity of software (SW information) that is a target for vulnerability checking, in accordance with the flowchart of FIG. 8, and determines whether or not there is a vulnerability in the target for checking in response to the calculated degree of activity (or whether or not the probability of a vulnerability being present is high). In other words, the distribution server 10 determines whether or not it is necessary to execute checking as to whether or not the checking target is present in the terminal 30. Concretely, the distribution server 10 executes the following analysis using the public information database 12 configured based on the collected public information.

First, the public information analysis part 15 extracts, from the public information database 12, an entry corresponding to a checking target identified from the already obtained vulnerability checking information (step S301). On this occasion, the public information analysis part 15 refers to an obtained data and time field of the public information database 12, and extracts an entry having SW information corresponding to a vulnerability checking target among entries within a prescribed time period.

In the example of FIG. 6, if version 01 of software A (SW_A; V01) and version 02 of software B (SW_B; V02) are vulnerability checking targets, entries where obtained information IDs are ID1-ID9 are extracted.

Next, the public information analysis part 15 identifies an entry related to a new vulnerability among the extracted entries (step S302). Concretely, the public information analysis part 15 calculates difference for a set of entries having non-new vulnerability terms from a set of entries having vulnerability terms, and identifies an entry related to a new vulnerability.

In the example of FIG. 6, since entries ID2, ID6, ID8 include non-new vulnerability terms, a set of entries excluding these: {ID1, ID3, ID4, ID5, ID7, ID9} is identified.

Thereafter, for each of the entries (information exchange), the public information analysis part 15 performs an estimation using SW information as to which software the information exchange is performed (step S303).

In the example of FIG. 6, information exchange entries related to version 01 of software A are ID1, ID3, ID4, ID7. Information exchange entries related to version 02 of software B are ID5, ID9.

Next, the public information analysis part 15 gives a ranking to respective SW information items based on the estimated entries (step S304). Concretely, the public information analysis part 15 counts the number of entries for which information exchange has been performed for each SW information item, and calculates the degree of activity.

In the abovementioned example, since there are 4 entries related to version 01 of software A, the degree of activity is “4”. Since there are 2 entries related to version 02 of software B, the degree of activity is “2”. In this way, the public information analysis part 15 excludes descriptions that include non-new vulnerability terms, among the collected descriptions, and calculates a degree of activity (evaluation score).

The public information analysis part 15 lists up the calculated degrees of activity and ranks the SW information. In the abovementioned example, SW information related to version 01 of software A is ranked above SW information related to version 02 of software B.

The public information analysis part 15 transmits N (N is an arbitrary positive integer; the same applies below) SW information items from the top of the created ranking, as “new vulnerability information”, to the vulnerability information management part 23 of the management server 20 (instruct checking from the top rank; step S305). For example, in the abovementioned example, SW information related to version 01 of software A is transmitted to the management server 20 as new vulnerability information.

In the abovementioned description, the public information analysis part 15 generates new vulnerability information from the N upper positions in the generated ranking, but new vulnerability information may also be generated from SW information having a degree of activity greater than or equal to a prescribed threshold. That is, the public information analysis part 15 transmits information identifying software that is a target for vulnerability checking corresponding to degree of activity matching a predetermined condition, as “new vulnerability information” to the management server 20.

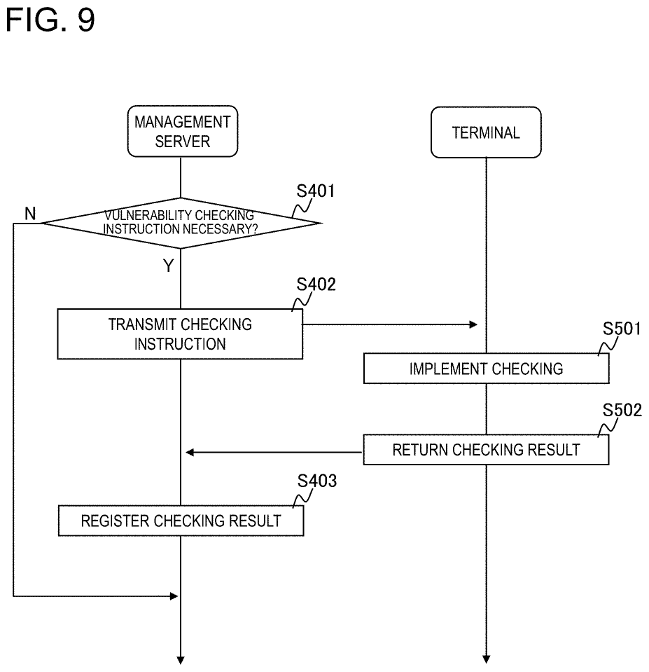

Subsequently, a description is given concerning management operations of the management server 20. FIG. 9 is a sequence diagram showing an example of operations of the management server 20 and the terminal 30.

The vulnerability information management part 23 of the management server 20 refers to a terminal information database 22, and determines whether or not it is necessary to instruct the terminal 30 to check new vulnerability information (step S401). Concretely, the vulnerability information management part 23 performs the abovementioned determination in response to whether or not the abovementioned new vulnerability information is included in the terminal information database 22.

That is, if the new vulnerability information is registered in the terminal information database 22, since this means that software corresponding to the new vulnerability information in question is installed in the terminal 30, the vulnerability information management part 23 determines that a new checking instruction is unnecessary.

If the new vulnerability information is registered in the terminal information database 22, since it is not clear whether or not software corresponding to the new vulnerability information in question is installed in the terminal 30, the vulnerability information management part 23 determines that a checking instruction is necessary.

If a checking instruction is unnecessary (step S401; No branch), processing is ended.

If the checking instruction is necessary (step S401; Yes branch), the vulnerability information management part 23 transmits a checking instruction to the terminal 30 (step S402). Concretely, the vulnerability information management part 23 transmits the new vulnerability information to the terminal 30, and gives an instruction to check whether or not software corresponding to the information in question is included in the terminal 30.

In the terminal 30 that receives the checking instruction, the checking countermeasure execution part 32 implements checking (step S501). Thereafter, the checking countermeasure result returning part 33 of the terminal 30 returns a checking result to the management server 20 (step S502).

A terminal information management part 24 of the management server 20 registers the checking result in the terminal information database 22 (step S403).

It is to be noted that running concurrently with the abovementioned checking, the management server 20 preferably gives notification of estimated information (new vulnerability information) related to setting items of software for which checking is thought necessary, by transmitting a management screen, email or the like to the administrator. The administrator that receives the notification in question can make an addition of information in accordance with registration flow in a checking method, depending on the necessity.

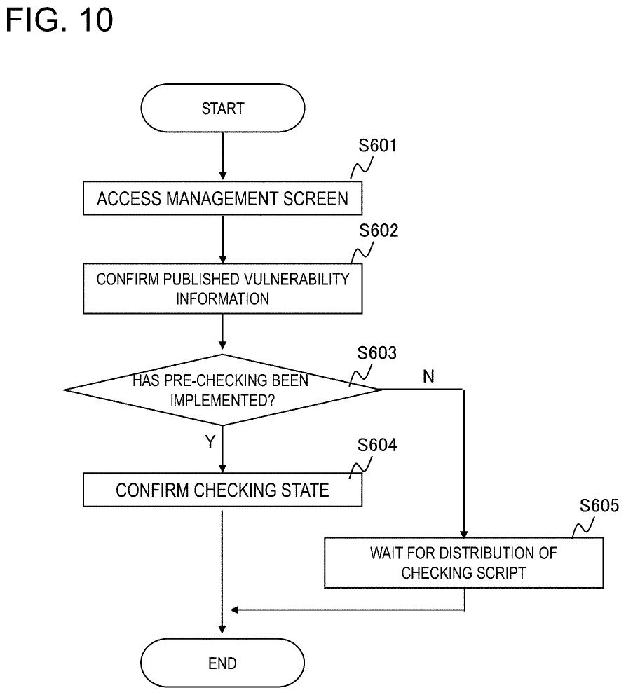

Next, a description is given concerning operations of confirming a vulnerability by a administrator. FIG. 10 is a flowchart showing an example of operations of confirming vulnerability by the administrator.

The administrator accesses a management screen provided by the management server 20 and confirms vulnerability information currently published (steps S601, S602).

In the case of an item for which checking is started in advance (if advance checking by the terminal 30 is finished), the administrator confirms checking state of each terminal 30 (step S603, Yes branch; step S604).

In the case of an item for which checking is not started in advance, the administrator waits for distribution of a checking script by a software provider (step S603, No branch; step S605).

As described above, the distribution server 10 according to the first exemplary embodiment obtains descriptions including pre-registered SW information, vulnerability terms, and non-new vulnerability terms, not only from a site provided by a vendor, but also from sites in what is called the dark web. In a community formed in the dark web or the like, vulnerability information may be exchanged before publishing of official vulnerability information by the vendor. The distribution server 10 actively collects information from such sites, and estimates the possibility of the existence of vulnerability in software before information related to vulnerabilities is officially announced by the vendor. Concretely, if there is active discussion concerning vulnerability related to particular software or a particular version in the abovementioned sites, the distribution server 10 estimates that some type of vulnerability exists in the abovementioned particular software and version. As a result, the management server 20 can promptly execute checking in advance as to whether or not software of a version where a vulnerability is suspected is installed in a terminal 30 that is a target for management, before the vulnerability is made public by the vendor.

That is, in a case where vulnerability information is published in a vendor site or the like, without waiting for distribution of a checking script by the software provider, it is possible to start checking immediately with regard to terminals inside an organization, and time until publication can be shortened. In other words, it is possible to implement plural checks in advance, by estimation from the degree of activity even before publication of vulnerability information. As a result, even if the vulnerability information in question is published, it is possible to have a situation in which checking is already started, and time until checking is completed can be shortened.

### [Modified Example]

The configuration and operations of the system described in the abovementioned exemplary embodiments are exemplary, and there is no intent to limit the configuration and operations of the system. For example, functionality of the management server 20 may be embedded in the distribution server 10.

With regard to registering vulnerability checking information in the distribution server 10, in addition to registering a checking script manually, technology to automatically generate a checking script by analysis of keywords may also be combined therewith.

In the abovementioned exemplary embodiment, new vulnerability information is generated based on degree of activity, but degree of importance of each site may also be taken into account when generating the information. For example, handling is possible by giving a high score to a degree of activity generated from descriptions obtained from a site with a high degree of importance.

In the multiple flowcharts used as described above, a plurality of steps (processes) were described in order, but the order of executing the steps executed in the various exemplary embodiments is not limited to the order described. In the various exemplary embodiments, modification is possible within a scope where there is no substantive interference in the order of the illustrated steps, such as executing the respective processes in parallel or the like. The various exemplary embodiments described above may be combined within a scope that does not conflict with the content.

Some or all of the abovementioned exemplary embodiments may also be described as in the following modes, but there is no limitation to the following.

### [Mode 1]

As in the vulnerability checking system according to the first aspect described above.

### [Mode 2]

The vulnerability checking system preferably according to Mode 1,

wherein the collection part collects descriptions including at least one of: software information that uniquely identifies the software, a vulnerability term related to a vulnerability of the software, and a non-new vulnerability term used when information exchange related to a known vulnerability is performed.

### [Mode 3]

The vulnerability checking system preferably according to Mode 2,

wherein the analysis part calculates the degree of activity, excluding descriptions that include the non-new vulnerability term, among the collected descriptions.

### [Mode 4]

The vulnerability checking system preferably according to any one of Modes 1 to 3,

wherein the analysis part obtains vulnerability checking information in order to identify software that is the target for vulnerability checking.

### [Mode 5]

The vulnerability checking system preferably according to any one of Modes 1 to 4,

wherein the collection part collects descriptions related to vulnerability of software, based on information related to a site that is accessed in order to collect descriptions related to vulnerability of the software.

### [Mode 6]

The vulnerability checking system preferably according to any one of Modes 1 to 5,

wherein the analysis part transmits information identifying software that is the target for vulnerability checking corresponding to the degree of activity matching a predetermined condition, as the new vulnerability information, to the management server.

### [Mode 7]

The vulnerability checking system preferably according to Mode 6,

wherein the management server instructs the terminal to check the state of software in the terminal, the software being identified from the new vulnerability information.

### [Mode 8]

As in the distribution server according to the second aspect described above.

### [Mode 9]

As in the vulnerability checking method according to the third aspect described above.

### [Mode 10]

As in the program according to the fourth aspect described above.

It is to be noted that the eighth to tenth modes may be extended with regard to the second to seventh modes, similar to the first mode.

It is to be noted that the disclosures of the abovementioned cited patent literature are incorporated herein by reference thereto. Modifications and adjustments of exemplary embodiments and examples may be made within the bounds of the entire disclosure (including the scope of the claims) of the present invention, and also based on fundamental technological concepts thereof. Various combinations and selections of various disclosed elements (including respective elements of the respective claims, respective elements of the respective exemplary embodiments and examples, respective elements of the respective drawings, and the like) are possible within the scope of the entire disclosure of the present invention. That is, the present invention clearly includes every type of transformation and modification that a person skilled in the art can realize according to the entire disclosure including the scope of the claims and to technological concepts thereof. In particular, with regard to numerical ranges described in the present specification, arbitrary numerical values and small ranges included in the relevant ranges should be interpreted to be concretely described even where there is no particular description thereof.

### REFERENCE SIGNS LIST

10, 103 distribution server
11, 21 vulnerability information database (DB)
12 public information database (DB)
13, 23 vulnerability information management part
14 public information collection part
15 public information analysis part
20, 102 management server
22, 31 terminal information database (DB)
24 terminal information management part
25 management screen providing part
30, 101 terminal
32 checking countermeasure execution part
33 checking countermeasure result returning part
40 Web published information
51 CPU (Central Processing Unit)
52 memory
53 input output interface
54 NIC (Network Interface Card)
111 collection part
112 analysis part Docket No.

What is claimed is:

1. A vulnerability checking system comprising:
a terminal;
a management server that manages software installed in the terminal; and
a distribution server that distributes information related to software in which a vulnerability is estimated to be present, as new vulnerability information, to the management server;
wherein the distribution server comprises:
a collection part that collects descriptions related to vulnerability of software, from information published on a network; and
an analysis part that analyzes the collected descriptions, calculates, as a degree of activity, the number of descriptions related to vulnerability of software that is a target for vulnerability checking within a prescribed period, and generates the new vulnerability information according to the calculated degree of activity.

2. The vulnerability checking system according to claim 1,
wherein the collection part collects descriptions including at least one of: software information that uniquely identifies the software, a vulnerability term related to a vulnerability of the software, and a non-new vulnerability term used when information exchange related to a known vulnerability is performed.

3. The vulnerability checking system according to claim 2,
wherein the analysis part calculates the degree of activity, excluding descriptions that include the non-new vulnerability term, among the collected descriptions.

4. The vulnerability checking system according to claim 1,
wherein the analysis part obtains vulnerability checking information in order to identify software that is the target for vulnerability checking.

5. The vulnerability checking system according to claim 1,
wherein the collection part collects descriptions related to vulnerability of software, based on information related to a site that is accessed in order to collect descriptions related to vulnerability of the software.

6. The vulnerability checking system according to claim 1,
wherein the analysis part transmits information identifying software that is the target for vulnerability checking corresponding to the degree of activity matching a predetermined condition, as the new vulnerability information, to the management server.

7. The vulnerability checking system according to claim 6,
wherein the management server instructs the terminal to check the state of software in the terminal, the software being identified from the new vulnerability information.

8. A distribution server, comprising:
a collection part that collects descriptions related to software vulnerability from information published on a network; and
an analysis part that analyzes the collected descriptions, calculates, as a degree of activity, the number of descriptions related to vulnerability of software that is a target for vulnerability checking within a prescribed period, and generates new vulnerability information that is information related to software in which a vulnerability is estimated to be present, according to the calculated degree of activity;
wherein the new vulnerability information is distributed to a management server that manages software installed in a terminal.

9. A vulnerability checking method, in a distribution server that distributes information related to software in which a vulnerability is estimated to be present, as new vulnerability information, to a management server that manages software installed in a terminal, the method, comprising:
collecting descriptions related to software vulnerability from information published on a network;
analyzing the collected descriptions and calculating, as a degree of activity, the number of descriptions related to vulnerability of software that is a target for vulnerability checking within a prescribed period; and
generating new vulnerability information that is information related to software in which a vulnerability is estimated to be present, according to the calculated degree of activity.

10. A computer-readable non-transient recording medium recording a program, the program causing a computer installed in a distribution server that distributes information related to software in which a vulnerability is estimated to be present, as new vulnerability information, to a management server that manages software installed in a terminal, to execute processing, comprising:
collecting descriptions related to software vulnerability from information published on a network;
analyzing the collected descriptions and calculating, as a degree of activity, the number of descriptions related to vulnerability of software that is a target for vulnerability checking within a prescribed period; and
generating new vulnerability information that is information related to software in which a vulnerability is estimated to be present, according to the calculated degree of activity.

11. The distribution server according to claim 8,
wherein the collection part collects descriptions including at least one of: software information that uniquely identifies the software, a vulnerability term related to a vulnerability of the software, and a non-new vulnerability term used when information exchange related to a known vulnerability is performed.

12. The distribution server according to claim 11,
wherein the analysis part calculates the degree of activity, excluding descriptions that include the non-new vulnerability term, among the collected descriptions.

13. The distribution server according to claim 8,
wherein the analysis part obtains vulnerability checking information in order to identify software that is the target for vulnerability checking.

14. The distribution server according to claim 8,
wherein the collection part collects descriptions related to vulnerability of software, based on information related to a site that is accessed in order to collect descriptions related to vulnerability of the software.

15. The distribution server according to claim 8,
wherein the analysis part transmits information identifying software that is the target for vulnerability checking corresponding to the degree of activity matching a predetermined condition, as the new vulnerability information, to the management server.

16. The vulnerability checking method according to claim 9,
wherein in the collecting, descriptions including at least one of: software information that uniquely identifies the software, a vulnerability term related to a vulnerability of the software, and a non-new vulnerability term used when information exchange related to a known vulnerability is performed, are collected.

17. The vulnerability checking method according to claim 16,
wherein in the analyzing, the degree of activity, excluding descriptions that include the non-new vulnerability term, among the collected descriptions is calculated.

18. The vulnerability checking method according to claim 9,
wherein in the analyzing, vulnerability checking information in order to identify software that is the target for vulnerability checking, is obtained.

19. The vulnerability checking method according to claim 9,
wherein in the collecting, descriptions related to vulnerability of software, based on information related to a site that is accessed in order to collect descriptions related to vulnerability of the software, are collected.

20. The vulnerability checking method according to claim 9, the method further comprising;
transmitting information identifying software that is the target for vulnerability checking corresponding to the degree of activity matching a predetermined condition, as the new vulnerability information, to the management server.

21. The medium according to claim 10,
wherein in the collecting, descriptions including at least one of: software information that uniquely identifies the software, a vulnerability term related to a vulnerability of the software, and a non-new vulnerability term used when information exchange related to a known vulnerability is performed, are collected.

22. The medium according to claim 21,
wherein in the analyzing, the degree of activity, excluding descriptions that include the non-new vulnerability term, among the collected descriptions, is calculated.

23. The medium according to claim 10,
wherein in the analyzing, vulnerability checking information in order to identify software that is the target for vulnerability checking, is obtained.

24. The medium according to claim 10,
wherein in the collecting, descriptions related to vulnerability of software, based on information related to a site that is accessed in order to collect descriptions related to vulnerability of the software, are collected.

25. The medium according to claim 10, the program further causing a computer to execute processing of transmitting information identifying software that is the target for vulnerability checking corresponding to the degree of activity matching a predetermined condition, as the new vulnerability information, to the management server.
